(19) United States
(12) Patent Application Publication
(10) Pub. No.: US 2014/0283495 A1
(43) Pub. Date: Sep. 25, 2014

(54) Apple and Fruit Harvester

(71) Applicant: Arthur Christensen, Towson, MD (US)

(72) Inventor: Arthur Christensen, Towson, MD (US)

(21) Appl. No.: 13/850,285

(22) Filed: Mar. 25, 2013

(51) Int. Cl. A01D 46/00

(52) U.S. Cl. CPC A01D 46/00
USPC 56/332

(57) ABSTRACT

A fruit harvester has an extensible pole and a cutting head unit connected to the pole. The cutting head unit includes a pair of opposing cutting blades moveable such that a stem placed between the pair of opposing cutting blades is severed upon movement of the cutting blades from an open position to a closed position. A solenoid is attached to the pair of cutting blades to move the pair of cutting blades between the open position and the closed position. A chute located below the pair of opposing cutting blades has a rigid portion with a first opening and a second. The pair of opposing cutting blades is disposed over the first opening, and a flexible portion is attached over second opening. An electrical switch in communication with the solenoid initiates movement by the solenoid of the cutting blades between the open and closed positions.

### FIELD OF THE INVENTION

The present invention relates to fruit harvesting devices.

### BACKGROUND OF THE INVENTION

Conventional methods for picking fruit such as apples, pears, oranges, grapefruits and avocados involve either hand picking the fruit or using hand-held picking devices. Prior hand-held fruit picking devices to pull the fruit from the plant or to sever the stem holding the fruit to the plant upon harvesting have been attempted. Examples of existing hand-held picking devices are found in U.S. Pat. Nos. 4,531,352, 5,724,799, 5,083,418 and 5,386,682. In general, these hand-held fruit pickers are mounted on elongated poles including extensible poles. Mounted at one end of the pole is either a cutting mechanism to sever stems or a gripping mechanism to grasp the fruit and pull the fruit from the tree. A bag or other basket structure can also be provided to receive the fruit upon picking.

These known hand-held picking devices, however, suffer from a number of disadvantages. For example, hand-held fruit pickers that utilize only grasping mechanisms or that have only one cutting edge rely on pulling or tugging to grasp and to dislodge the fruit, requiring a pulling motion that can result in damage to the fruit or unintended dislodging of other fruit on the same plant. In addition, grasping or touching the fruit can result in cutting the fruit itself. Further, the stem must be cut since pulling the fruit could cause the stem to be pulled out of the fruit releasing juice leading to rotting or attracting insects to feed on the fruit or lay eggs in the fruit. These fruit pickers rely on manual actuators to sever the stem. These actuating mechanisms require that the operator apply physical force to the actuator. These mechanisms utilize numerous moving parts that add to the weight or the unit. The bulk of these devices in combination, for example, with rigid or opaque baskets limit visibility of fruit at the time of picking and inhibit engagement of the picking device with the fruit. Therefore, an improved fruit picking device is desired that is easy to use fruit picker with a reliable cutting mechanism that does not damage the fruit, cuts the fruit stem keeping the stem intact with the fruit and facilitates visibility of fruit throughout the harvesting process.

### SUMMARY OF THE INVENTION

Exemplary embodiments of systems and methods in accordance with the present invention provide an apple and fruit harvester that can be used by an operator to harvest fruit with stems intact from fruit trees.

The apple and fruit harvester includes a pole having a top end and a bottom end, and a cutting head unit which may be removable and connected to the top end of the pole. The pole being of sufficient length to facilitate harvesting of fruits by an operator located a distance from the fruit. The cutting head unit connected to the upper end of the pole including a pair of blades, two handles, a basket, a solenoid-driven actuator, and a threaded socket. The blades having a front tip and an end base extend along a longitudinal axis. The blades are configured to pivot about their end base where a pin is used to secure the two blades to one another. The blades pivot to form a V-shape in the open position such that respective cutting edges of the two blades align with one another. Two handles extend along the longitudinal axis where a first stationary handle is in contact with the end base of the pair of blades and a second moveable handle is attached to a connector connecting the moveable handle to the stationary handle and the end base of the pair of blades. A basket is disposed near the end base of the blades such that cut fruit are directed downwards into the basket.

In one embodiment, a battery-powered solenoid is in contact with the stationary handle and with wires. The solenoid drives an actuating motion to bring the blades together to cut stemmed fruit. The wires are directly in contact with the moveable handle. A threaded socket is in contact with the stationary handle and serves to connect the pole to the cutting head unit.

The pole is extendable and enables the operator to reach fruits located a distance from the operator base. The pole connects to the cutting head unit by attachment to either the threaded socket or other connection mechanism. Multiple poles can be connected and wired together.

The two handles are extendable and optionally include a plurality of distinct segments and a plurality of connections. Each connection is disposed between adjacent pairs of segments and extending along the longitudinal axis. The connections may be threaded or incorporate other connecting methods. The basket ensures visibility of the fruit while cutting to reduce damage to fruit. The basket further includes at least one of wire, molded plastic, polymer, mesh, and any combination thereof.

In one embodiment, the cutting head unit includes a battery-operated solenoid. The battery is carried by the operator of the apple and fruit harvester. The solenoid wires are connected from one handle to the next and further extend from the cutting head to the battery by electrical connectors. The wires can be fastened either to the outside of the handles or contained within the handles such that the solenoid connectors are exposed in order to connect with the battery.

In another embodiment, the cutting head unit includes an operator-assisted manual actuating mechanism. A trigger mechanism having a two-force tension member connects the operator with the manual actuating mechanism in order to drive an actuating motion to bring the blades together to cut stemmed fruit.

### BRIEF DESCRIPTION OF THE DRAWINGS

FIG. 1 is an illustration of an embodiment of a fruit harvester in accordance with the present invention being used to pick fruit from a tree;

FIG. 2 is a side view of an embodiment of a fruit harvester in accordance with the present invention;

FIG. 3 is a perspective view from the top of another embodiment of the fruit harvester in accordance with the present invention; and

FIG. 4 is a side view of an embodiment of a fruit harvester in accordance with the present invention.

### DETAILED DESCRIPTION

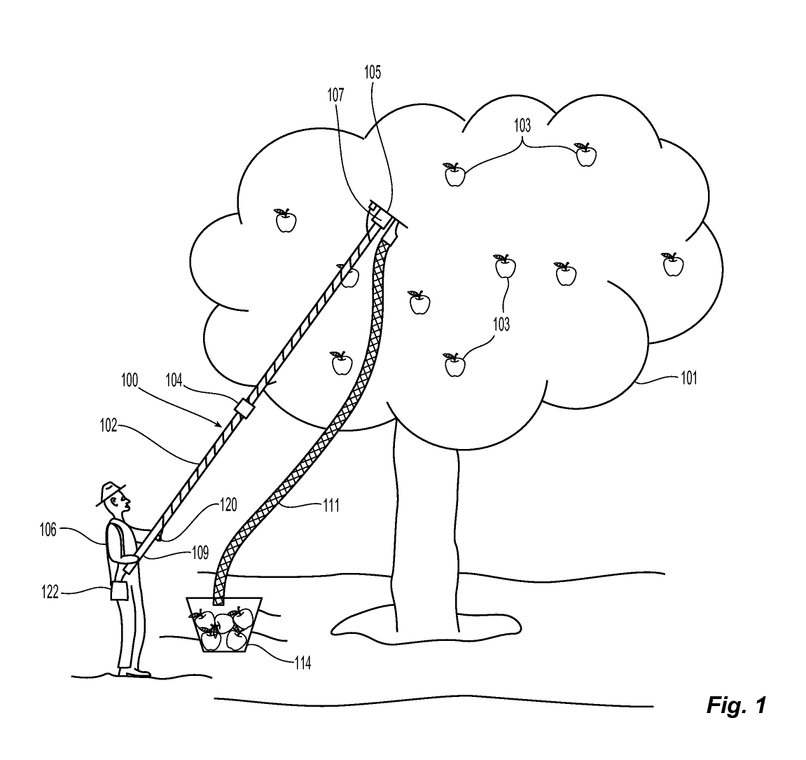

Referring initially to FIG. 1, an exemplary embodiment of a fruit harvester 100 in accordance with the present invention harvesting fruit 103 from a plant 101 on which the fruit are growing is illustrated. The fruit harvester is used to harvest a variety of fruits including, but not limited to, apples, pears, peaches, citrus fruit including oranges, lemons, limes and grapefruits, cherries and mangos growing on plants including trees and bushes. The fruit harvester utilizes a cutting head unit 105 attached to an elongated pole 102 adjacent a first end 107 of the pole. A user or worker 106 grasps the pole, for example near a second end 109 of the pole opposite the first end. The worker then selectively positions the cutting head unit 105 to harvest the fruit 103, which directs the fruit through a flexible chute portion 111 of the cutting head unit to a collection container 114 such as a basket, box or bag positioned adjacent the user, for example on the ground. This allows the user to harvest the fruit without having to climb a ladder and pick the fruit by hand. In one embodiment, the pole is removable from the cutting head unit, facilitating the cleaning, transport, and storage of the apple and fruit harvester.

The pole can be of fixed length or can be extensible. Suitable extensible poles include telescoping poles that can be extended and locked into a plurality of different lengths. In addition, the pole can be constructed from a plurality of pole sections that are selectively connected together at one or more joints 104 along the length of the pole. Suitable joints include, but are not limited to, threaded joints. The second end of the pole can be held in the hand of the user. Alternatively, the second end of the pole can be placed in a harness worn by the user to distribute the weight of the fruit harvester to the shoulders and hips of the user, further reducing fatigue. Suitable pole harnesses are known and available in the art such as those used to carry flag poles. In one embodiment, the second end of the pole is placed on the ground or other suitable mounting surface. The mounting surface can include a swivel mount to facilitate movement and positioning of the fruit harvester. In another embodiment, the second end of the fruit harvester is mounted on a tractor or other mechanized equipment to utilize the mobility and power of the tractor including electrical power and hydraulic power.

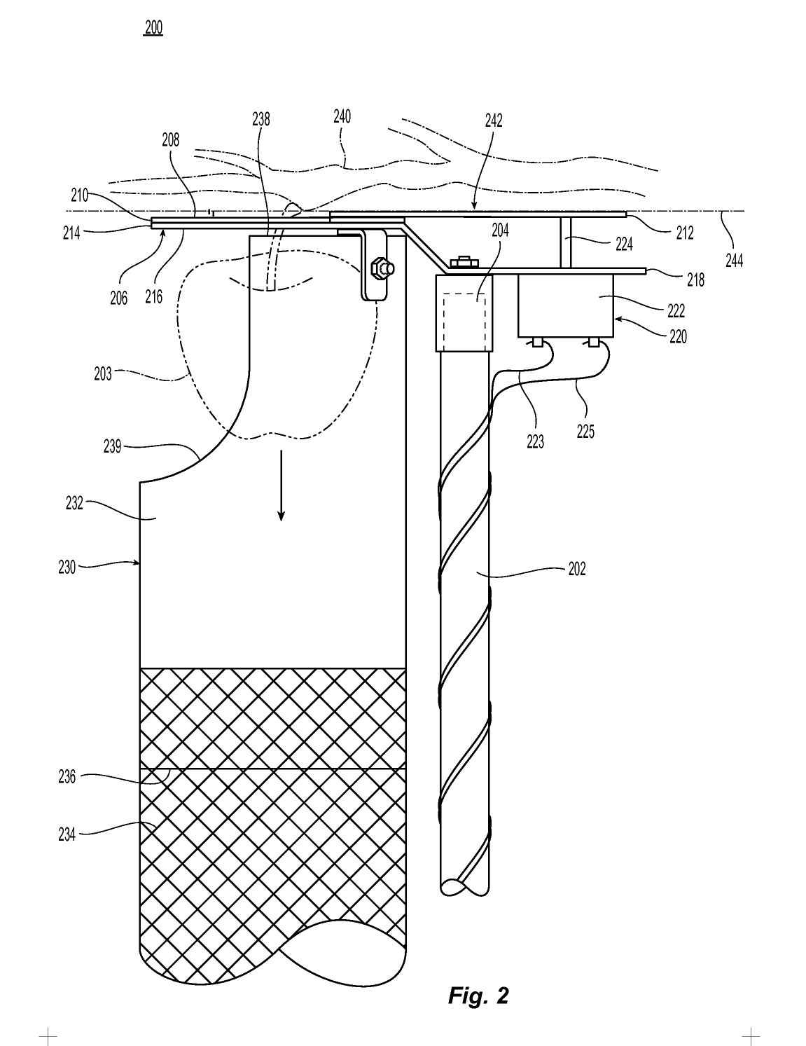

Referring to FIG. 2, in one exemplary embodiment, the fruit harvester 200 includes the pole 202 and the cutting head 206 attached to pole adjacent the first end 204. Suitable materials for the pole include, but are not limited to, wood, metal, polymers, composite materials and combinations thereof. The pole is attached to the cutting head using any suitable attachment mechanism including threaded fittings, fasteners and welds. The cutting head unit includes a pair of opposing cutting blades moveable with respect to each other from an open position to a closed position such that an object placed between the pair of opposing cutting blades, for example, the stem of the fruit 203 to be harvested, is severed upon movement of the cutting blades from the open position to the closed position. Suitable types of opposing cutting blades include anvil type cutting blades and scissor type cutting blades, as is understood by one skilled in the art. In one embodiment, this pair of opposing cutting blades includes a first cutting blade 208 having a first blade portion 210 and a first handle portion 212 and a second cutting blade 214 having a second blade portion 216 and a second handle portion 218. In one embodiment, the first handle portion is pivotally attached to the second handle portion. The blade and handle portions can be arranged as separate and distinct parts connected together or can be formed from a single piece of material. Suitable materials for the cutting blades include, but at not limited to, metals including stainless steel. In the embodiment as illustrated, the second handle portion is attached to the pole. Therefore, the second handle portion is fixed and the first handle portion moves relative to the second handle portion, moving the first blade portion relative to the second blade portion in a scissors action parallel to an axis extending outward from the illustrated drawing. In one embodiment, the cutting head can include a biasing member (not shown) to bias the cutting blades in the open or closed position as desired. Suitable biasing members include, but are not limited to, springs. In one embodiment, the biasing member is placed between the first and second handle portions.

Referring again to FIG. 2, the cutting head unit also includes a power assisted actuator mechanism 220 in communication with the pair of cutting blades to move the pair of cutting blades between the open position and the closed position. In particular, the power assisted actuator mechanism is in contact with the first and second handle portions of the pair of cutting blades. The power assisted actuator mechanism obviates the need for the user to supply the physical or mechanical force directly to the pair of cutting blades in order to sever the stem of the fruit. In general, the power assisted actuator mechanism includes at least two parts that move relative to each other using power derived, for example, from electricity, fluids or pressurized air. In one embodiment, the power assisted actuator mechanism includes a body 222 attached to the second handle portion and a piston 224 extending from the body portion and attached to the first handle portion. This piston moves with respect to the body, moving the first handle with respect to the second handle and the first blade portion with respect to the second blade portion. Suitable power assisted actuator mechanisms include, but are not limited to, an electro-mechanical mechanism, a pneumatic mechanism, a hydraulic mechanism and combinations thereof. Preferably, the power assisted actuator mechanism is a solenoid. As illustrated, the power assisted actuator mechanism moves the handle portions relative to each other in a first direction, e.g., vertically, moving the blades portions relative to each other is a second direction transverse to the first direction, e.g., horizontally. Therefore, the cutting blades also include additional structures to translate movement of the handles in one direction to movement of the blades in a transverse direction. Suitable additional structures are known and available in the art.

In order to initiate movement by the power assisted actuator mechanism of the cutting blades between the open position and the closed position, the fruit harvester includes a trigger mechanism 120 (FIG. 1) in communication with the power assisted actuator mechanism. Preferably, the trigger mechanism is located adjacent the user, for example on the pole adjacent the second end. The trigger mechanism selectively supplies the desired power or working fluid, i.e., air or hydraulic fluid, to the power assisted actuator mechanism. This is supplied through wires or lines running from the trigger mechanism to the power assisted actuator mechanism. In one embodiment, the trigger mechanism is an electrical switch. This electrical switch is in communication with the power assisted actuator mechanism, e.g., the solenoid, through electrical leads 223, 225, running along the length of the pole. These leads can be wrapped around the pole or incorporated into the structure of the pole to provide for extension of the pole.

In one embodiment, the trigger mechanism is a switch in wireless communication with the power assisted actuator mechanism. In one embodiment, the fruit harvester further includes an electrical power source 122 (FIG. 1) in communication with the electrical switch. Suitable electrical power sources include batteries, for example carried in a harness attached to the user. In addition, the electrical power source can be a battery pack that plugs into a receptacle disposed in the pole, for example adjacent the second end. These battery packs can be universal battery packs such as those commercially available for use with a variety of electric power tools. Other sources of power, i.e., generators, compressors and hydraulic takeoffs on tractors, can also be provided in communication with the trigger mechanism.

Returning to FIG. 2, the fruit harvester includes a chute 230 in communication with the pair of opposing cutting blades. This chute includes a rigid portion 232 having a first opening 238 and a second opening 236 opposite the first opening that is in communication with the first opening through the hollow interior of the chute. In one embodiment, the rigid portion is a cylindrical hollow plastic tube, the first and second openings disposed at opposite ends of the cylindrical hollow plastic tube and in communication through a hollow interior passing through the cylindrical hollow plastic tube. Preferably, the cylindrical hollow plastic tube comprises a transparent material. The pair of opposing cutting blades is disposed over the first opening. In one embodiment, the second handle portion is fixedly attached to the rigid portion of the chute, using suitable fasteners and frame members as required. In one embodiment, the pole is attached to the rigid portion of the chute. In one embodiment, the rigid portion includes a side opening 239 extending along a length of the cylindrical hollow plastic tube and in communication with the first opening. This side opening has a sufficient open area to allow passage of the fruit 203 to be picked into the hollow interior of the cylindrical hollow plastic tube without having to pass through the first or second openings. This facilitates placement of the stem between the first and second cutting blade portions close to the branch 240 to which the fruit stem is attached. The hollow interior is of sufficient size to accommodate the fruit to be harvested without damaging the fruit or constricting movement of the fruit through the rigid portion of the fruit tube.

The chute includes a flexible portion 234 attached to the rigid portion around the second opening. Suitable methods for attachment include, but are not limited to, welds, adhesives, fasteners and straps. In one embodiment, the flexible portion is a polymer mesh sleeve. The flexible portion has a sufficient length to direct the harvest fruit to a desired location for collection, e.g., to the ground. In addition, the size and inherent lubricity of the flexible portion is selected to provide for adequate movement of the harvested fruit through the flexible portion under the force of gravity while limiting the rate of descent through the flexible portion to minimize damage to the harvested fruit.

The cutting head unit has an end face 242 that is placed in proximity with the branch 240 on which the fruit to be harvested is attached. The power assisted actuator mechanism, the chute, the pole and the trigger mechanism, i.e., all of the components of the cutting head unit, are disposed on a same side of the end face, i.e., opposite the location of the branch. This arrangement, in cooperation with the side opening in the rigid portion of the chute facilitates placement of the cutting blades as close to the branch as possible, preserving a sufficient length of the stem. In one embodiment, the end face 242 defines an end face plane 244 and at least one of the first and second cutting blades is disposed in the end face plane.

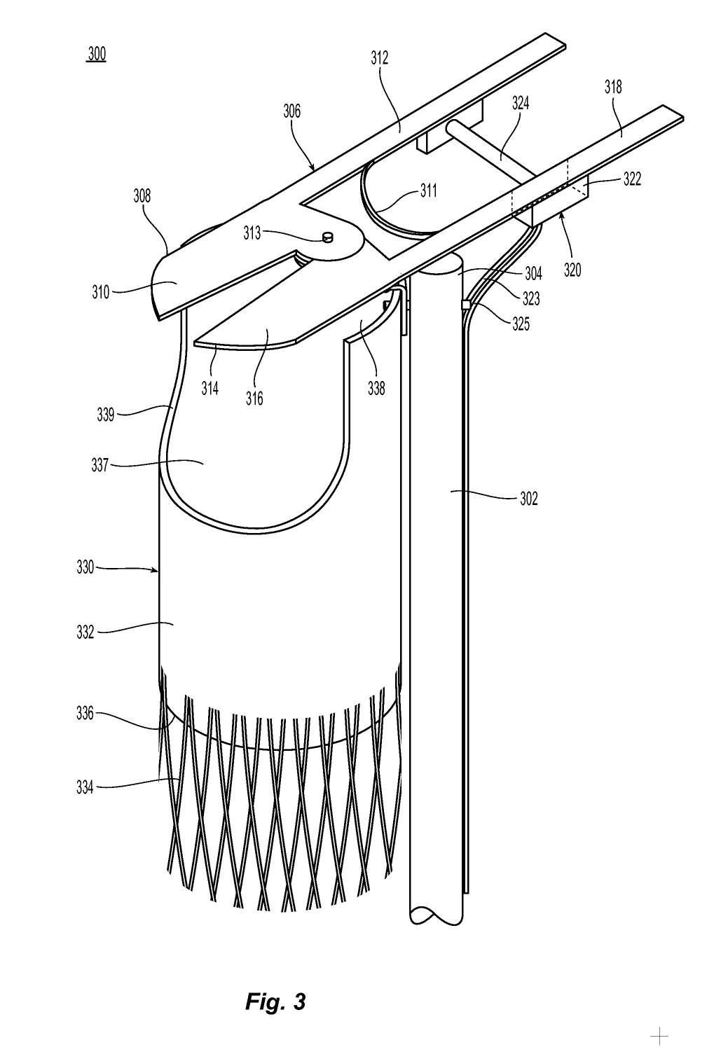

Referring to FIG. 3, another exemplary embodiment of the fruit harvester 300 in accordance with the present invention is illustrated. The fruit harvester includes the pole 302 and the cutting head 306 disposed adjacent the first end 304 of the pole. However, the cutting head is not directly attached to the pole. In addition, the cutting head unit includes a pair of opposing cutting blades in an anvil-type arrangement, i.e., the cutting blades do not cross. The cutting blades are moveable with respect to each other from an open position to a closed position such that an object placed between the pair of opposing cutting blades is severed upon movement of the cutting blades from the open position to the closed position. In this embodiment, the pair of opposing cutting blades includes a first cutting blade 308 having a first blade portion 310 and a first handle portion 312 and a second cutting blade 314 having a second blade portion 316 and a second handle portion 318. The first handle portion is pivotally attached to the second handle portion about a pivot point 313. The blade and handle portions can be arranged as separate and distinct parts connected together but are preferably formed from a single piece of material. Suitable materials for the cutting blades include, but at not limited to, metals including stainless steel. The second handle portion is fixed, and the first handle portion moves relative to the second handle portion, moving the first blade portion relative to the second blade portion in a common plane. In one embodiment, the cutting head can include a biasing member 311 to bias the cutting blades in the open or closed position as desired. Suitable biasing members include, but are not limited to, springs. In one embodiment, the biasing member is placed between the first and second handle portions.

The cutting head unit also includes a power assisted actuator mechanism 320 in communication with the pair of cutting blades to move the pair of cutting blades between the open position and the closed position. In particular, the power assisted actuator mechanism is on contact with the first and second handle portions of the pair of cutting blades. The power assisted actuator mechanism obviates the need for the use to apply physical or mechanical force directly to the pair of cutting blades in order to sever the stem of the fruit. In general, the power assisted actuator mechanism includes at least two parts that move relative to each other using power derived from electricity, fluids or pressurized air. In one embodiment, the power assisted actuator mechanism includes a body 322 attached to the second handle portion and a piston 324 extending from the body portion and attached to the first handle portion. This piston moves with respect to the body, moving the first handle with respect to the second handle and the first blade portion with respect to the second blade portion. As the handle portions are moved away from each other, the first and second blade portions are moved toward each other. Suitable power assisted actuator mechanisms include, but are not limited to, an electro-mechanical mechanism, a pneumatic mechanism, a hydraulic mechanism and combinations thereof. Preferably, the power assisted actuator mechanism is a solenoid.

The embodiment also utilizes a trigger mechanism 120 (FIG. 1) in communication with the power assisted actuator mechanism. Preferably, the trigger mechanism is located adjacent the user, for example on the pole adjacent the second end. The trigger mechanism selectively supplies the desired power or working fluid, i.e., air or hydraulic fluid, to the power assisted actuator mechanism. This is supplied through wires or lines running from the trigger mechanism to the power assisted actuator mechanism. In one embodiment, the trigger mechanism is an electrical switch. This electrical switch is in communication with the power assisted actuator mechanism, e.g., the solenoid, through electrical leads 323, 325, running along the length of the pole. This leads can be wrapped around the pole or incorporated into the structure of the pole to provide for extension of the pole.

In one embodiment, the trigger mechanism is a switch in wireless communication with the power assisted actuator mechanism. In one embodiment, the fruit harvester further includes an electrical power source 122 (FIG. 1) in communication with the electrical switch. Suitable electrical power sources include batteries, for example carried in a harness attached to the user. In addition, the electrical power source can be a battery pack that plugs into a receptacle disposed in the pole, for example adjacent the second end. These battery packs can be universal battery packs such as those commercially available for use with a variety of electric power tools. Other sources of power, i.e., generators, compressors and hydraulic takeoffs on tractors, can also be provided in communication with the trigger mechanism.

Returning to FIG. 3, the fruit harvester includes a chute 330 in communication with the pair of opposing cutting blades. This chute includes a rigid portion 332 having comprising a first opening 338 and a second opening 336 opposite the first opening that is in communication with the first opening through the hollow interior 337 of the chute. As illustrated, the pole is secured to the rigid portion of the chute using any suitable attachment mechanism including adhesives, welds and one or more fasteners. In one embodiment, the rigid portion comprises a cylindrical hollow plastic tube, the first and second openings disposed at opposite ends of the cylindrical hollow plastic tube and in communication through a hollow interior passing through the cylindrical hollow plastic tube. Preferably, the cylindrical hollow plastic tube comprises a transparent material. The pair of opposing cutting blades is disposed over the first opening. In one embodiment, the second handle portion is fixedly attached to the rigid portion of the chute, using suitable fasteners and frame members are required. In one embodiment, the pole is attached to the rigid portion of the chute. In one embodiment, the rigid portion includes a side opening 339 extending along a length of the cylindrical hollow plastic tube and in communication with the first opening. This side opening has a sufficient open area to allow passage of the fruit to be picked into the hollow interior of the cylindrical hollow plastic tube without having to pass through the first or second openings. This facilitates placement of the stem between the first and second cutting blade portions close to the branch to which the fruit stem is attached. The hollow interior is of sufficient size to accommodate the fruit to be harvest without damaging the fruit or constricting movement of the fruit through the rigid portion of the fruit.

The chute includes a flexible portion 334 attached to the rigid portion around the second opening. Suitable methods for attached include, but are not limited to, welds, adhesives, fasteners and straps. The flexible portion has a sufficient length to direct the harvest fruit to a desired location for collection, e.g., to the ground. In addition, the size and smoothness of the flexible portion is selected to provide for adequate movement of the harvested fruit through the flexible portion to minimize damage to the harvested fruit. The flexible portion is constructed of a material that can flex or expand slightly in size, i.e., in internal diameter, to accommodate the size of the fruit passing through the flexible portion. In addition, the smoothness of the flexible portion is a property of the material from which the flexible portion is constructed. In one embodiment, the flexible portion is a polymer mesh sleeve. Preferably, the flexible portion is low density polyethylene (LDPE), and the flexible portion benefits from the inherent lubricity and flexibility of LDPE.

As with the scissor-type embodiment described above, the cutting head unit has an end face that is placed in proximity with the branch on which the fruit to be harvested is attached. The power assisted actuator mechanism, the chute, the pole and the trigger mechanism, i.e., all of the components of the cutting head unit, are disposed on a same side of the end face, i.e., opposite the location of the branch. This arrangement, in cooperation with the side opening in the rigid portion of the chute facilitates placement of the cutting blades as close to the branch as possible, preserving a sufficient length of the stem. In one embodiment, the end face defines an end face plane, and the first and second cutting blades are disposed in the end face plane.

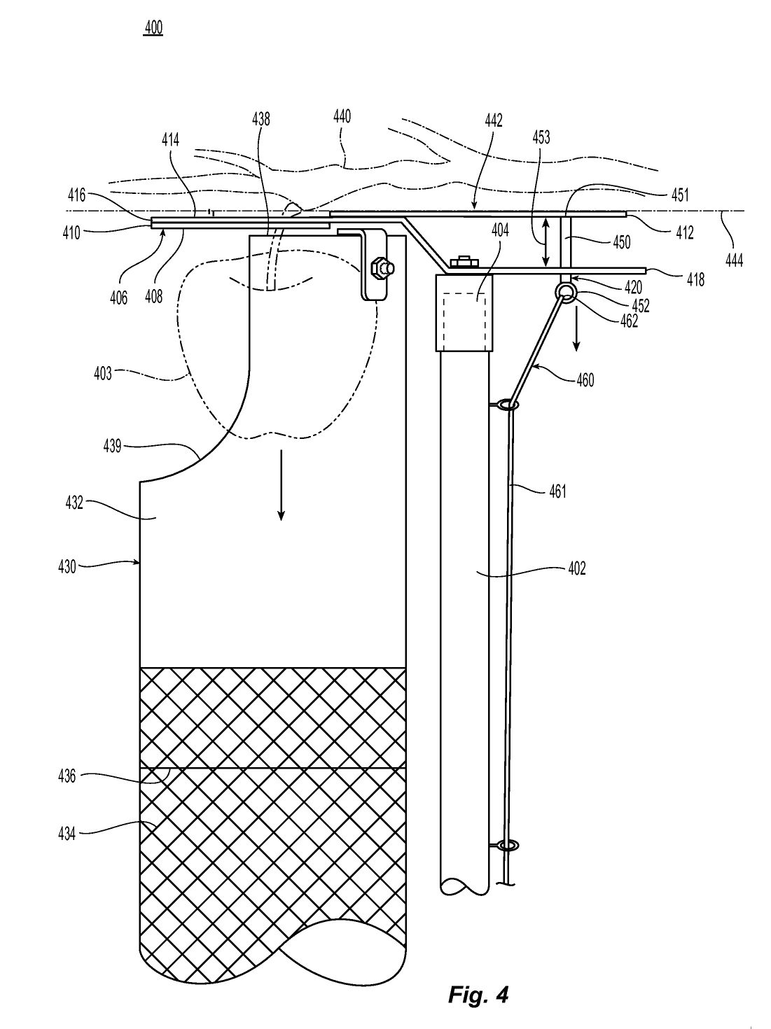

Referring to FIG. 4, in one exemplary embodiment, the fruit harvester 400 utilizes a manual actuating mechanism and includes the pole 402 and the cutting head 406 attached to the pole adjacent the first end 404. Suitable materials for the pole include, but are not limited to, wood, metal, polymers, composite materials and combinations thereof. The pole is attached to the cutting head using any suitable attachment mechanism including threaded fittings, fasteners and welds. The cutting head unit includes a pair of opposing cutting blades moveable with respect to each other from an open position to a closed position such that an object placed between the pair of opposing cutting blades, for example, the stem of the fruit 403 to be harvested, is severed upon movement of the cutting blades from the open position to the closed position. Suitable types of opposing cutting blades include anvil type cutting blades and scissor type cutting blades, as is understood by one skilled in the art. In one embodiment, this pair of opposing cutting blades includes a first cutting blade 408 having a first blade portion 410 and a first handle portion 412 and a second cutting blade 414 having a second blade portion 416 and a second handle portion 418. In one embodiment, the first handle portion is pivotally attached to the second handle portion.

The blade and handle portions can be arranged as separate and distinct parts connected together or can be formed from a single piece of material. Suitable materials for the cutting blades include, but at not limited to, metals including stainless steel. In the embodiment as illustrated, the second handle portion is attached to the pole. Therefore, the second handle portion is fixed and the first handle portion moves relative to the second handle portion, moving the first blade portion relative to the second blade portion in a scissors action parallel to an axis extending outward from the illustrated drawing. In one embodiment, the cutting head can include a biasing member (not shown) to bias the cutting blades in the open or closed position as desired. Suitable biasing members include, but are not limited to, springs. In one embodiment, the biasing member is placed between the first and second handle portions.

The cutting head unit includes a manual actuator mechanism 420 in communication with the pair of cutting blades to move the pair of cutting blades between the open position and the closed position. In particular, the manual actuator mechanism is in contact with at least one of the first and second handle portions of the pair of cutting blades. In one embodiment, the manual actuator mechanism includes a pin 450 having a proximal end 451 attached to the second handle portion and a distal end 452 opposite the proximal end. The distal end is configured for attachment to a trigger mechanism 460. Wherein force is applied by the trigger mechanism to the distal end of the pin, the first handle moves with respect to the second handle, moving the first blade portion with respect to the second blade portion. In one embodiment, the pin passes through the first handle portion such that first handle portion is disposed between the proximal and distal ends of the pin. As illustrated, the manual actuator mechanism moves the handle portions relative to each other in a first direction 453, e.g., vertically, moving the blades portions relative to each other is a second direction transverse to the first direction, e.g., horizontally. Therefore, the cutting blades also include additional structures to translate movement of the handles in one direction to movement of the blades in a transverse direction. Suitable additional structures are known and available in the art.

In order to initiate movement by the manual actuator mechanism of the cutting blades between the open position and the closed position, the fruit harvester includes a trigger mechanism 460 in communication with the manual actuator mechanism. Preferably, the trigger mechanism extends to a location, adjacent the user, for example on the pole adjacent the second end. The trigger mechanism selectively supplies the desired force to the manual actuator mechanism. In one embodiment, the trigger mechanism includes a tension 461 member extending along the pole and having an engagement end 462 in contact with the distal end of the pin portion of the manual actuator mechanism and a trigger end (not shown) opposite the engagement end and located adjacent the second end of the pole. In one embodiment, the tension member is constructed from single filament wire, braided wire, rope, cord, string, a metal bar or combinations thereof.

The fruit harvester includes a chute 430 in communication with the pair of opposing cutting blades. This chute includes a rigid portion 432 having a first opening 438 and a second opening 436 opposite the first opening that is in communication with the first opening through the hollow interior of the chute. In one embodiment, the rigid portion is a cylindrical hollow plastic tube, the first and second openings disposed at opposite ends of the cylindrical hollow plastic tube and in communication through a hollow interior passing through the cylindrical hollow plastic tube. Preferably, the cylindrical hollow plastic tube comprises a transparent material. The pair of opposing cutting blades is disposed over the first opening. In one embodiment, the second handle portion is fixedly attached to the rigid portion of the chute, using suitable fasteners and frame members as required. In one embodiment, the pole is attached to the rigid portion of the chute. In one embodiment, the rigid portion includes a side opening 439 extending along a length of the cylindrical hollow plastic tube and in communication with the first opening. This side opening has a sufficient open area to allow passage of the fruit 403 to be picked into the hollow interior of the cylindrical hollow plastic tube without having to pass through the first or second openings. This facilitates placement of the stem between the first and second cutting blade portions close to the branch 440 to which the fruit stem is attached. The hollow interior is of sufficient size to accommodate the fruit to be harvested without damaging the fruit or constricting movement of the fruit through the rigid portion of the fruit tube.

The chute includes a flexible portion 434 attached to the rigid portion around the second opening. Suitable methods for attachment include, but are not limited to, welds, adhesives, fasteners and straps. In one embodiment, the flexible portion is a polymer mesh sleeve. The flexible portion has a sufficient length to direct the harvest fruit to a desired location for collection, e.g., to the ground. In addition, the size and inherent lubricity of the flexible portion is selected to provide for adequate movement of the harvested fruit through the flexible portion under the force of gravity while limiting the rate of descent through the flexible portion to minimize damage to the harvested fruit.

The cutting head unit has an end face 442 that is placed in proximity with the branch 440 on which the fruit to be harvested is attached. The power assisted actuator mechanism, the chute, the pole and the trigger mechanism, i.e., all of the components of the cutting head unit, are disposed on a same side of the end face, i.e., opposite the location of the branch. This arrangement, in cooperation with the side opening in the rigid portion of the chute facilitates placement of the cutting blades as close to the branch as possible, preserving a sufficient length of the stem. In one embodiment, the end face 442 defines an end face plane 444 and at least one of the first and second cutting blades is disposed in the end face plane.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s) and steps or elements from methods in accordance with the present invention can be executed or performed in any suitable order. Therefore, it will be understood that the appended claims are intended to cover all such modifications and embodiments, which would come within the spirit and scope of the present invention.

1. A fruit harvester comprising:
a pole comprising a first end and a second end opposite the first end;
a cutting head unit connected to the pole adjacent the first end, the cutting head unit comprising:
a pair of opposing cutting blades moveable with respect to each other from an open position to a closed position such that an object placed between the pair of opposing cutting blades is severed upon movement of the cutting blades from the open position to the closed position;
a power assisted actuator mechanism in communication with the pair of cutting blades to move the pair of cutting blades between the open position and the closed position; and
a chute in communication with the pair of opposing cutting blades, the chute comprising:
a rigid portion comprising a first opening and a second opening opposite the first opening, the pair of opposing cutting blades disposed over the first opening; and
a flexible portion attached to the rigid portion around the second opening; and
a trigger mechanism in communication with the power assisted actuator mechanism to initiate movement by the power assisted actuator mechanism of the cutting blades between the open position and the closed position.

2. The fruit harvester of claim 1, wherein the pole comprises an extensible pole.

3. The fruit harvester of claim 1, wherein the cutting head unit further comprises an end face, the pair of opposing cutting blades, the power assisted actuator mechanism, the chute, the pole and the trigger mechanism disposed on a same side of the end face.

4. The fruit harvester of claim 3, wherein:
the end face defines an end face plane; and
the pair of opposing cutting blades comprise a first cutting blade and a second cutting blade, at least one of the first and second cutting blades disposed in the end face plane.

5. The fruit harvester of claim 1, wherein:
the pair of opposing cutting blades comprises:
a first cutting blade comprising a first blade portion and a first handle portion; and
a second cutting blade comprising a second blade portion and a second handle portion, the second handle portion fixedly attached to the rigid portion of the chute and the first handle portion pivotally attached to the second handle portion; and
the power assisted actuator mechanism comprises:
a body attached to the second handle portion; and
a piston extending from the body portion and attached to the first handle portion;
wherein movement of the piston with respect to the body moves the first handle with respect to the second handle, moving the first blade portion with respect to the second blade portion.

6. The fruit harvester of claim 1, wherein the power assisted actuator mechanism comprises an electro-mechanical mechanism, a pneumatic mechanism, a hydraulic mechanism or combinations thereof.

7. The fruit harvester of claim 1, wherein the power assisted actuator mechanism comprises a solenoid.

8. The fruit harvester of claim 7, wherein:
the trigger mechanism comprises an electrical switch; and
the fruit harvester further comprises an electrical power source in communication with the electrical switch.

9. The fruit harvester of claim 8, wherein the electrical switch is attached to the pole adjacent the second end.

10. The fruit harvester of claim 1, wherein the rigid portion comprises a cylindrical hollow plastic tube, the first and second openings disposed at opposite ends of the cylindrical hollow plastic tube and in communication through a hollow interior passing through the cylindrical hollow plastic tube.

11. The fruit harvester of claim 10, wherein the cylindrical hollow plastic tube comprises a transparent material.

12. The fruit harvester of claim 10, wherein the rigid portion further comprises a side opening extending along a length of the cylindrical hollow plastic tube and in communication with the first opening, the side opening comprising a sufficient open area to allow passage of a fruit to be picked into the hollow interior of the cylindrical hollow plastic tube.

13. The fruit harvester of claim 1, wherein the flexible portion comprises a polymer mesh sleeve.

14. A fruit harvester comprising:
a pole comprising a first end and a second end opposite the first end;
a cutting head unit connected to the pole adjacent the first end, the cutting head unit comprising:
a pair of opposing cutting blades moveable with respect to each other from an open position to a closed position such that an object placed between the pair of opposing cutting blades is severed upon movement of the cutting blades from the open position to the closed position, the pair of opposing cutting blades comprising:
a first cutting blade comprising a first blade portion and a first handle portion; and
a second cutting blade comprising a second blade portion and a second handle portion, the first handle portion pivotally attached to the second handle portion; and
a solenoid in communication with the pair of cutting blades to move the pair of cutting blades between the open position and the closed position, the solenoid comprising:
a body attached to the second handle portion; and
a piston extending from the body portion and attached to the first handle portion, wherein movement of the piston with respect to the body moves the first handle with respect to the second handle, moving the first blade portion with respect to the second blade portion; and
a chute in communication with the pair of opposing cutting blades, the chute comprising:
a rigid portion comprising a first opening and a second opening opposite the first opening, the pair of opposing cutting blades disposed over the first opening and the second handle portion fixedly attached to the rigid portion of the chute; and
a flexible portion attached to the rigid portion around the second opening; and
an electrical switch in communication with the solenoid to initiate movement by the solenoid of the cutting blades between the open position and the closed position.

15. A fruit harvester comprising:
a pole comprising a first end and a second end opposite the first end;
a cutting head unit connected to the pole adjacent the first end, the cutting head unit comprising:
a pair of opposing cutting blades moveable with respect to each other from an open position to a closed position such that an object placed between the pair of opposing cutting blades is severed upon movement of the cutting blades from the open position to the closed position;
a manual actuator mechanism in communication with the pair of cutting blades to move the pair of cutting blades between the open position and the closed position; and
a chute in communication with the pair of opposing cutting blades, the chute comprising:
a rigid portion comprising a first opening and a second opening opposite the first opening, the pair of opposing cutting blades disposed over the first opening; and
a flexible portion attached to the rigid portion around the second opening; and
a trigger mechanism in communication with the manual actuator mechanism to initiate movement by the manual actuator mechanism of the cutting blades between the open position and the closed position, the trigger mechanism comprising a tension member extending along the pole and comprising an engagement end in contact with the manual actuator mechanism and a trigger end opposite the engagement end and located adjacent the second end of the pole.

16. The fruit harvester of claim 15, wherein:
the pair of opposing cutting blades comprises:
a first cutting blade comprising a first blade portion and a first handle portion; and
a second cutting blade comprising a second blade portion and a second handle portion, the second handle portion fixedly attached to the rigid portion of the chute and the first handle portion pivotally attached to the second handle portion; and
the manual actuator mechanism comprises a pin comprising:
a proximal end attached to the first handle portion; and
a distal end opposite the proximal end, the distal end in contact with the engagement end of the tension member;
wherein force applied by the trigger mechanism to the distal end of the pin moves the first handle with respect to the second handle, moving the first blade portion with respect to the second blade portion.

17. The fruit harvester of claim 16, wherein the pin passes through the second handle portion such that second handle portion is disposed between the proximal and distal ends of the pin.

18. The fruit harvester of claim 15, wherein the tension member comprises single filament wire, braided wire, rope, cord, string, a metal bar or combinations thereof.

19. The fruit harvester of claim 15, wherein:
the rigid portion comprises:
a cylindrical hollow plastic tube comprising a transparent material, the first and second openings disposed at opposite ends of the cylindrical hollow plastic tube and in communication through a hollow interior passing through the cylindrical hollow plastic tube; and
a side opening extending along a length of the cylindrical hollow plastic tube and in communication with the first opening, the side opening comprising a sufficient open area to allow passage of a fruit to be picked into the hollow interior of the cylindrical hollow plastic tube; and
the flexible portion comprises a polymer mesh sleeve.

20. The fruit harvester of claim 15, wherein:
the cutting head unit further comprises an end face defining an end face plane; and
the pair of opposing cutting blades, the manual actuator mechanism, the chute, the pole and the line disposed on a same side of the end face plane.
